(19) United States
(12) Patent Application Publication
(10) Pub. No.: US 2012/0271980 A1
(43) Pub. Date: Oct. 25, 2012

(54) TEST DEVICE AND METHOD FOR TESTING SERIAL PORTS OF COMPUTING DEVICE

(75) Inventor: MING-XIANG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/167,722

(22) Filed: Jun. 24, 2011

(30) Foreign Application Priority Data
Apr. 19, 2011 (CN) 201110097296.X

(51) Int. Cl. G06F 13/40

(52) U.S. Cl. 710/316

(57) ABSTRACT

A test device for testing serial ports of the computing device includes a multiplexer, a USB interface, a signal conversion unit, a switch unit, and multiple serial port interfaces. The USB interface is connected to a USB port of the computing device. Each of the serial port interfaces is connected to a serial port of the computing device. The signal conversion unit is connected to the USB interface of the test device, and connected to the serial port interfaces through the multiplexer. The signal conversion unit converts serial signals into USB signals, or converts USB signals into serial signals, to transmit testing signals between the USB port and the serial ports. The switch unit controls a serial port to be tested to connect to the signal conversion unit through the multiplexer, to form a test channel to test functions of the serial port.

### BACKGROUND

1. Technical Field

Embodiments of the present disclosure relate generally to serial port testing, and more particularly, to a test device and method for testing serial ports of a computing device.

2. Description of Related Art

Most computing devices comprise one or more serial ports to connect with one or more peripherals. Each of the serial ports needs to be tested during the production of the computing devices. In a testing method of the serial ports, the serial ports are tested by connecting each of the serial ports to a terminal server. When one of the serial ports is tested, another one of the serial ports may be manually connected to the terminal server. This testing method is slow and inconvenient.

### BRIEF DESCRIPTION OF THE DRAWINGS

FIG. 1 is a block diagram of one embodiment of a test device.

FIG. 2 is a flowchart of one embodiment of a method for testing serial ports of the computing device using the test device of FIG. 1.

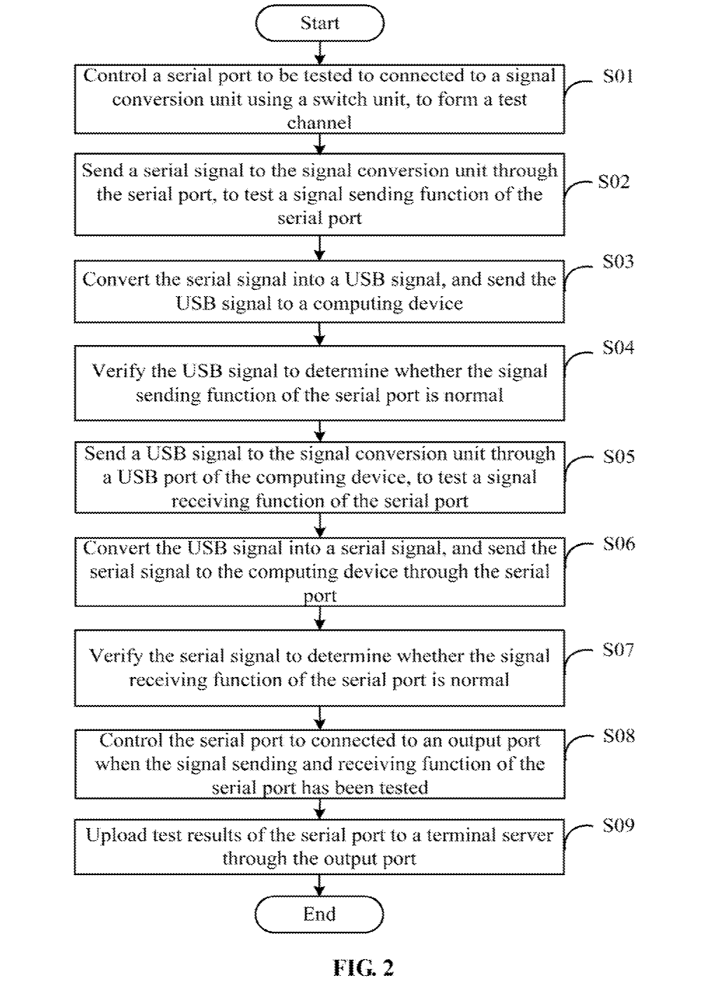

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

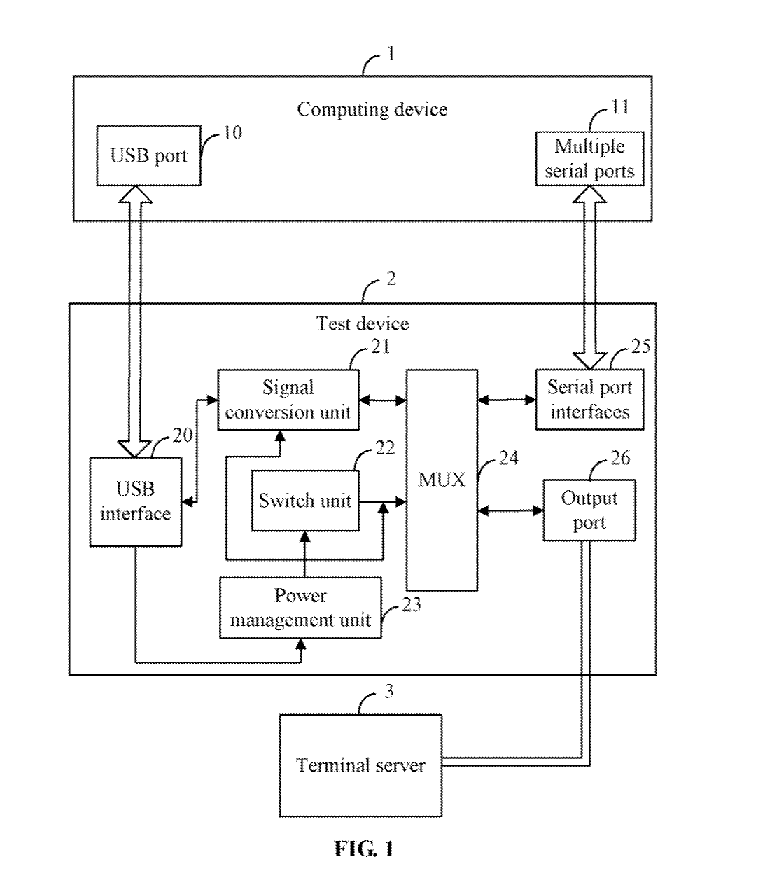

FIG. 1 is a block diagram of one embodiment of a test device 2. In the embodiment, the test device 2 includes a universal serial bus (USB) interface 20, a signal conversion unit 21, a switch unit 22, a power management unit 23, a multiplexer (MUX) 24, a plurality of serial port interfaces 25, and an output port 26. The test device 2 is connected to a computing device 1 and a terminal server 3. The computing device 1 includes a USB port 10 and multiple serial ports 11. The USB interface 20 is connected to the USB port 10. Each of the serial ports 11 is respectively connected to one of the serial port interfaces 25, so that the serial ports 11 may be tested using the test device 2. The terminal server 3 is connected to the test device 2 through the output port 26, so that the computing device 1 may upload test results of the serial ports 11 to the terminal server 3 through the output port 26.

The signal conversion unit 21 is connected to the USB interface 20, and connected to the serial port interfaces 25 through the multiplexer 24. During the process of testing the serial ports 11, the computing device 1 may send testing signals to the test device 2 for testing the serial ports 11. In one embodiment, the testing signals may include USB signals transmitted from the USB port 10, and serial signals transmitted from the serial ports 11. The signal conversion unit 21 is operable to convert the serial signals transmitted from the serial ports 11 into USB signals, or convert the USB signals transmitted from the USB port 10 into serial signals, so that testing signals can be transmitted between the USB port 10 and the serial ports 11.

The switch unit 22 is connected to the multiplexer 24. The switch unit 22 is operable to form a test channel between a serial port 11 and the USB port 10 by controlling the serial port 11 to communicate with the signal conversion unit 21 through the multiplexer 24. When the serial port 11 has been tested, the switch unit 22 is further operable to control the serial port 11 to connect to the output port 26 through the multiplexer 24, so that the computing device 1 can upload a testing result of the serial port 11 to the terminal server 3 through the output port 26.

The power management unit 23 is connected to the USB interface 20, the signal conversion unit 21, the switch unit 22, and the multiplexer 24. The power management unit 23 is operable to provide a voltage output from the USB interface 20 to the signal version unit 21, the switch unit 22, and the multiplexer 24.

FIG. 3 is a flowchart of one embodiment of a method for testing serial ports 11 of the computing device 1 using the test device 2 of FIG. 1. Depending on the embodiment, additional blocks may be added, others removed, and the ordering of the blocks may be changed.

In block S01, the switch unit 22 controls a serial port 11 to be tested to connect to the signal conversion unit 21, to form a test channel between the serial port 11 and the USB port 10.

In block S02, the computing device 1 sends a serial signal to the signal conversion unit 21 through the serial port 11, to test a signal sending function of the serial port 11.

In block S03, the signal conversion unit 21 converts the serial signal into a USB signal, and sends the converted USB signal to the computing device 1 through the USB port 10.

In block S04, the computing device 1 verifies the converted USB signal to determine whether the signal sending function of the serial port 11 is normal. In one embodiment, if the converted USB signal is identical to the sent serial signal according to the verification, the computing device 1 determines that the signal sending function of the serial port 11 is normal. Otherwise, if the USB signal is not identical to the sent serial signal according to the verification, the computing device 1 determines that the signal sending function of the serial port 11 is abnormal.

In block S05, the computing device 1 sends a USB signal to the signal conversion unit 21 through the USB port 10, to test a signal receiving function of the serial port 11.

In block S06, the signal conversion unit 21 converts the USB signal into a serial signal, and sends the converted serial signal to the computing device 1 through the serial port 11.

In block S07, the computing device 1 verifies the serial signal to determine whether the signal receiving function of the serial port 11 is normal. In one embodiment, if the converted serial signal is identical to the sent USB signal according to the verification, the computing device 1 determines that the signal receiving function of the serial port 11 is normal. Otherwise, if the serial signal is not identical to the sent USB signal according to the verification, the computing device 1 determines that the signal receiving function of the serial port 11 is abnormal.

In block S08, the switch unit 22 controls the serial port 11 to connect to the output port 26 through the multiplexer 24 when the signal sending and receiving function of the serial port 11 has been tested.

In block S09, the computing device 1 uploads test results of the serial port 11 to the terminal server 3 through the output port 26. In one embodiment, the block S01 to S09 may be repeated to test the other serial port 11 of the computing device 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A test device for testing serial ports of a computing device, the test device comprising:
a multiplexer;
a universal serial bus (USB) interface that is connected to a USB port of the computing device;
a plurality of serial port interfaces, each of the serial port interfaces being connected to one of the serial ports;
a signal conversion unit that is connected to the USB interface, and connected to the serial port interfaces through the multiplexer; and
a switch unit operable to form a test channel between a serial port and the USB port by controlling the serial port to communicate with the signal conversion unit through the multiplexer;
wherein the signal conversion unit is operable to convert a serial signal into a USB signal when the serial signal is transmitted from the serial port, and send the converted USB signal to the computing device through the USB port to determine whether a signal sending function of the serial port is normal, or convert a USB signal into a serial signal when the USB signal is transmitted from the USB port, and send the converted serial signal to the computing device through the serial port to determine whether a signal receiving function of the serial port is normal.

2. The test device according to claim 1, further comprising:
a power management unit that is connected to the USB interface, the signal conversion unit, the switch unit, and the multiplexer.

3. The test device according to claim 2, wherein the power management unit is operable to provide a voltage output from the USB interface to the signal version unit, the switch unit, and the multiplexer.

4. The test device according to claim 1, further comprising:
an output port that is connected to a terminal server for uploading test results of the serial port to the terminal server through the output port using the computing device.

5. The test device according to claim 4, wherein the switch unit is further operable to control the serial port to connect to the output port through the multiplexer when the serial port has been tested, to upload the testing results of the serial port to the terminal server using the computing device through the output port.

6. A method for testing serial ports of a computing device, the computing device comprising a universal serial bus (USB) port, the method comprising;
providing a test device connected to the computing device, wherein the test device comprises a multiplexer, a USB interface, a plurality of serial port interfaces, a switch unit, and a signal conversion unit;
forming a test channel between the serial port and the USB port by controlling one of the serial ports to communicate with the signal conversion unit using the switch unit;
converting a serial signal into a USB signal using the signal conversion unit when the serial signal is transmitted from the serial port;
sending the USB signal to the computing device through the USB port;
verifying the USB signal to determine whether a signal sending function of the serial port is normal;
converting a USB signal into a serial signal using the signal conversion unit when the USB signal is transmitted from the USB port;
sending the serial signal to the computing device through the serial port; and
verifying the serial signal to determine whether a signal receiving function of the serial port is normal.

7. The method according to claim 6, further comprising:
controlling the serial port to connect to the output port through the multiplexer when the signal sending and receiving function of the serial port has been tested; and
uploading test results of the serial port to the terminal server through the output port using the computing device.
